(19) United States
(12) Patent Application Publication
(10) Pub. No.: US 2005/0062198 A1
(43) Pub. Date: Mar. 24, 2005

(54) Automated method of injecting polymer to form a graphical design onto substrate

(76) Inventor: Phong Pham, La Porte, TX (US)

Correspondence Address: Phong C. Pham, 3622 Brookwood Dr., La Porte, TX, 77571, US

(21) Appl. No.: 10/664,607

(22) Filed: Sep. 19, 2003

(51) Int. Cl. B29C 31/00

(52) U.S. Cl. 264/259

(57) ABSTRACT

An automated method of injecting polymer onto a substrate using a controllable back plate to move said substrate to desire location for applying the polymer whereas the integrated pressure system delivers a predetermined amount of the polymeric material through a chilled transfer line adapted through a set of insulated die press members and a set of heated die press member where a necessary amount of heat is transferred to raise the temperature of the previously chilled polymeric material to a specified curing temperature, applying to the substrate, and consequentially providing an adhesive bond for said polymeric material to attach to the substrate without requiring a seal to be made between the die members and the substrate and a curing time to the process.

### BACKGROUND OF THE INVENTION

1. Field of the Invention

The present invention is an improved method relating to the manufacturing of graphical design representing art work, logos, text messages, replicas of photographic matter and the like which are grafted to supple substrate by non-homogeneous means of adhesive, stitches, ink or meshes. More particularly, the present invention improves the method for affixing graphical design elements to an outer surface of a supple or flexible substrate wherein the design includes polymers that are injected to the substrate by subjecting the substrate to the operations of the die press. The invention includes an automated method of injecting pressurized polymers through heated die press members and onto substrate forming a surface bonding to hold the graphic design to the substrate surface, and a back plate adapted to a movable die table for receiving, transferring the substrate through the operations of manufacturing the graphic design and depositing the substrate externally to the die press without requiring a heating cycle for curing after the polymeric substance has been injected. One of the operational aspects of the automated method and a personnel safety aspect of the automated method is the reduction of injury to human operators who frequently were exposed to the hot and pressurized fluid of the polymer as they were required to put their hands under the press to position the substrate onto a back plate, which is used to support the substrate and is directly below the die press or in the proximate area as used in the currently available machine for similar process of injecting polymer. Therefore, part of the novelty aspect of the invention includes providing a movable table adapted to engage a substrate, which is the object for transferring a graphic design onto, and eliminates the need to frequently expose the operators to the heated materials. Thus one object of the automated method is feeding the substrate to the die press, releasing the finished graphic design from the die members onto the substrate and, and then depositing it externally to the die members without further engaging the human operator to expose his or her hands under the die press to position or to remove the substrate. The die members are heated sufficiently to transfer the heat required to meet the curing conditions of various commercially available polymer materials.

2. General Background

The methods presently used for affixing artistic matter, printed matter, designs, logos, and the like to substrate can be divided into two general categories. One category of affixing a design element to a substrate by mechanical means is known by sewing a design element of cotton thread, fabric, felt, wool, and plastic. Another category of affixing a design element to a substrate by chemical means is known by silk-screening. Silk-screening or silk-screen printing is a process applying the inherent aspect of the chemical elements in the ink to transfer a flat color design through a piece of silk. The silk is used as a transfer media allowing the ink to reach the intended substrate following the pattern of a graphic design, which is defined by the physical confines set by the silk screen and the chemical confines set by a resin medium. The use of silk screening is popular because of its relatively low cost. However, this process is slow when multiple colors in a graphic design are required because the process is limited to one color per each application. Furthermore, a category for affixing a design element to a substrate includes polymer injection, which is further improved by this invention.

Many patents have issued that relate to the transfer of design elements to an article of clothing. Generally, the Harrison patent U.S. Pat. No. 6,241,930 discloses the following. An example of an early patent that discusses the attachment of insignia or appliques to clothing is the Holick patent U.S. Pat. No. 2,926,439 entitled “PROOF PLASTIC INSIGNIA AND NAME PLATE HOLDER-COVER”.

The application of pictures to a garment is discussed in U.S. Pat. No. 3,055,133 entitled “JACKET WITH PICTURE POCKETS” issued to Kenneth Anderson. The Anderson patent discloses a vest like jacket having rectangular pockets that are clear so that when photographs are placed in a pocket, they can be seen through the clear plastic material. The clear pockets are formed by a plastic material sewed upon the jacket and divided into individual pockets by cross-sewing.

A doll figure that has appliques is disclosed in the Vandis patent U.S. Pat. No. 4,710,145.

The Erhardt et al. patent U.S. Pat. No. 4,815,149 entitled “FABRIC CLOTHING INCLUDING A THREE DIMENSIONAL PATTERN” shows an article of apparel such as a T-shirt that includes multiple fabric layers. The T-shirts includes a fabric layer upon which is attached a three dimensional molded article providing a three dimensional relief pattern on the front part of the T-shirt. The three dimensional molded part includes a flat base disk and raised relief parts with the disk being attached to the T-shirt fabric leaving a hollow area in between the fabric and the raised parts.

An article of clothing to which a three dimensional applique has been applied to provide a decorative effect is disclosed in U.S. Pat. No. 4,837,864 issued to Thill. The Thill patent provides an applique that is of a flexible non-cloth material such as vinyl, various plastics or rubber which is attached to the front of panel of a T-shirt or sweater. The attachment is accomplished either through sewing or other positive connectors. The three dimensional applique is formed through various molding processes and the shirt or sweater may be cut to receive sane.

The Akada et al. patent U.S. Pat. No. 4,923,848 relates to image formation on any selected kind of objective body. The objective body is discussed as being cards, clothes, papers, and transparent sheets. An example of a garment having a decorative applique is seen in the Diaz patent U.S. Pat. No. 5,005,219. An image is manufactured directly on a garment, such as by silk-screening. Chenille is sewn about the border of the image, thereby creating a shape with a chenille outline and an interior image. The decorative shapes are said to be letters, numbers, mascots, characters or symbols.

Another patent that discusses the application of an applique to clothing is the LaGreca patent U.S. Pat. No. 5,241,919. In the LeGreca patent there is disclosed an applique design produced on a garment or other fabric article by providing a chenille material having a fabric base and a plurality of cut or looped threads extending from an upper surface of a fabric base and applying a flexible backing material to a lower surface of the chenille material. The chenille material is cut to form edges having an outline of a desired design and disposed over a garment or fabric base. A polymer film is overlaid on the upper surface of the chenille material and a design is stitched over the film to the chenille material and a garment or fabric base. The stitching comprises closely spaced thread, which covers and compresses portions of the film and chenille material. The film provides a barrier layer to prevent the thread loops from extending between the closely spaced thread of the stitching. The film is removed from the unstitched portions of the upper surface of the chenille material whereby the desired design is formed by the stitched and unstitched portions of the chenille material.

An example of a recent patent that relates to the display of art on a T-shirt or other textile product is U.S. Pat. No. 4,838,965 issued to Janice Bussard and entitled “HOLOGRAPHIC ART APPLIED TO T-SHIRTS OR OTHER TEXTILE PRODUCTS”. The Bussard '965 patent discloses a hologram being adhered to a textile fabric by means of a silk screen printing ink while at the same time printing a graphic on the textile; the ink embedding the hologram edges therein and the ink containing an ingredient to bond with the hologram.

Another Bussard patent is U.S. Pat. No. 5,314,767 entitled “HOLOGRAPHIC PRODUCTS WITH IMPROVED SEALS”. The '767 patent discloses an improved process for cutting and simultaneously sealing the cut edges of holographic materials comprising cutting with a hot cutting tool. Suitable cutting tools include a steel rule die, a hot tipped cutter, and a laser. The resulting product can be attached easily to a substrate and will resist delaminations even when attached to a substrate such as a textile material that will be subjected to ordinary washing and drying.

The Fry patents U.S. Pat. Nos. 4,956,040 and 5,073,222 relate to methods of adhering design elements to textile wearing apparel. Each of these patents discloses a method for adhering holograms to textile wearing apparel involving the steps of laminating a precut hologram between a clear polyester coating and an adhesive scrim backing to envelop the hologram and protect it from moisture and scuffing, cutting margins away from the laminated hologram to form an enveloped hologram and applying the enveloped hologram to wearing apparel at a temperature of between approximately two hundred seventy degrees and three hundred degrees Fahrenheit (270° F.-300° F.) under a pressure of approximately thirty to fifty (30 to 50) psi for a period of approximately eight to fifteen (8 to 15) seconds. A hologram becomes firmly adhered to the wearing apparel and remains impervious to moisture after repeated machine washing and drying cycles.

Recent patents that disclose the concept of an aperture garment having an envelope structure or pocket for displaying an article are the Fox patent U.S. Pat. No. 5,173,968 and the Kenneth et al. patent U.S. Pat. No. 5,398,345. The Fox '968 patent discloses an article constituted of pieces of self-adhesive pliable plastic which form a well sealed enveloping structure with may be manually unsealed and opened for the insertion of decorative or information conveying material and then manually closed again and well re-sealed at least one piece of plastic being transparent then at least one piece being selected so as to permit viewing of decorative information conveying material in the enveloping structure.

The Kenneth '345 patent discloses a combination aperture garment product and object adapted for securement in the pocket, where the pocket is attached to the garment by seams and has apertures therein. The object, which may be a teddy bear having appendages, is adapted to be removably secured in the pocket so that the appendages extend outside of the pocket through the apertures and are visible when positioned in the pocket. The apertures are arranged through the pocket panel spaced apart from the seams. The garment may have two dimensional graphic indicia arranged on it and the three dimensional object, when secured in the pocket, forms a part of the graphic indicia.

In addition, the Harrison patent U.S. Pat. No. 6,241,930 discloses a method of attaching an applique to a garment includes the providing of a die press member and a backing plate press member. This method requires the die member, the back plate and an injection moldable silicone polymer to be heated to a temperature of about 200-250 degrees Fahrenheit (200° F.-250° F.). In addition, it includes in the steps of the operation a time period for the silicone polymer to cure and the garment to be impregnated with silicone at the die cavity open area. As evidenced by the text of the patent, the attachment of the silicone polymer is created by continuously impregnating the garment within the periphery of the die cavities and from the outside surface to a position at least near the inside surface, preferably completely through the garment. Furthermore, the patent requires a seal to be created between the die member, the garment and the die plate when the polymeric material is applied. Another aspect of that invention requires the silicone to be delivered from two separate reservoirs to a static mixer before traveling to the injection barrel.

### SUMMARY OF THE INVENTION

The present invention provides an improved method of affixing a design element or graphical element or elements to a desired supple or flexible substrate. The method of the present invention provides an integrated control system with a Programmable Logic Control (PLC) for heat transfer, pressurization and delivery, an integrated injection system for delivering and metering a desired amount of polymer, and a die structure that includes a first die member having a graphical design element shaped die cavity on one face, a second die member being a layer of insulation, and a third member having a cooling system. The die is preferably an injection molding-type die. The die cavity can be shaped to include a number of different cavities at varied or constant depressions such as multiple letter shaped cavities for varied thickness or a combination of graphical and text design.

The die cavity has a thickness ranging about 1.0-3.5 mm and includes a first die surface area that occupies a plane and a peripheral surface that forms an angle of about ninety degrees (90°) with the first surface and with the plane. The die cavity area faces the substrate or a garment, in one of the preferred embodiments, at a desired location to apply the graphical design and is held at a near distance away from the garment creating a gap of sufficient space to allow the hot air and the gas forming from the heated silicone to vent outside the periphery as the silicone is ejected from the die cavities. The back plate serves as rigid support under the garment as it lays flat on the back plate. The die cavity is relatively positioned with the subject garment as the back plate moves the garment to the location facing the die cavity and sequentially deposits the garment after the injection is complete. Thus, the garment is moved to position in between the injection molding die member and the backing plate where the injection occurs and sequentially moved away from the die member to be removed from the back plate.

The injection molding die member is faced against the outside surface of the garment that is the surface that will display the graphic design. The backing plate member faces the inside surface of the garment and is positioned opposite the die member during the injection. The backing plate member is held in a static position as the die member approaches the garment until the die is located sufficiently to allow the air gap to form at the first die surface and the outside surface of the garment.

During the delivery process of the polymer injection, a liquid silicone polymer is drawn from a container to a metering injector connected to an injection pump. The metered injector is part of the metering process, which controls the formation of a desired volume of the silicone rubber sufficient to form the desired graphical design through a predetermined set point related to the displacement of the stroke of the injector. The desired volume of polymer is known as a shot or silicone shot. Accordingly, the length of the stroke determines the shot size. The injector is blocked by a corresponding ball valve while the polymer is filling inside the injector barrel according to the set point. The polymer travels to the liquid cooled injection nozzle and through the heated injection mold onto the substrate. During the course of travel, the polymer is delivered through the water cooled (jacketed) injection line and acquired sufficient heat as it contacts the heated wall of the hot section of the die members to raise its temperature to the curing the temperature as it is deposited forcefully onto the garment.

The die member is heated to a temperature of about 200-250 degrees Fahrenheit (200° F.-250° F.) in accordance with polymeric material used in the preferred embodiment. An injectable silicone polymer or silicone rubber is also heated within the die member to a temperature of about 200-250 degrees Fahrenheit (200° F.-250° F.). The silicone is heated on contact with the peripheral surface of the die cavity and injected onto the garment where a bonding occurs as the polymer comes into contact with the substrate outside surface opposing the die cavity open area.

The silicone polymer bonds to the garment within the periphery of the die cavity as the vacuum created by the escaping hot air and hot gas from the heating silicone is pushed from the surface of the garment under the pressure of the injection process. The bond is solidified as the silicone cools off on the surface of the substrate. This bonding forms a solid attachment of the silicone polymer to the garment within the time that the design is transferred from the design cavity of the injection molding die to the garment.

The present invention provides an improved garment article with a bonded graphical design. The improved article includes a garment having an outside surface displaying a graphical design, and a corresponding inside surface unmodified. A plurality of discrete and spaced apart graphical design elements of polymeric material is affixed to and bonded to the garment at spaced apart positions.

A plurality of the elements has varied heights of an outer flat surface, an inner flat surface, and a peripheral surface ranging from linear to curvilinear elements, the outer flat surface and peripheral surface intersecting at a crisp sharp edge.

Each element includes a portion of the bonded polymeric material attaching to the garment on the outside surface and over the surface area of each discrete element. The plurality of elements has a uniform thickness ranging about 1.0 and 3.5 mm.

### BRIEF DESCRIPTION OF THE DRAWINGS

FIG. 1 shows the general arrangement of the automated process of injecting polymer onto a substrate namely a garment 5A in one of the preferred embodiments with the integrated back plates 6A and 6B mounted on movable and controllable die tables 7A and 7B, die holder 1, and the degrees of movement are being shown by the arrows;

FIG. 2 is a perspective view illustrating the method of the present invention and particularly the finishing steps of manufacturing a graphical design on substrate namely garments 5A and 5B by injecting the polymer and then delivering the finished garment 5B externally from the die system comprising die holder 1, hydraulic ram 2, and guide shafts 3A and 3B;

FIG. 3 is a perspective view of die members comprising a cold plate 10 with IN and OUT chilled water connection and plug 12, an insulation plate 11, a hot plate 13 with die cavity 14, two heat input 15 and 17, and a temperature sensor 16 in communication with Programmable Logic Controller (PLC), bolts 18A, 18B, 18 C and 18D connect the die members 10, 11 and 13 to die holder 1 and dowel pins 19A and 19B hold the alignment of the die members;

FIG. 4 is a sectional perspective view of FIG. 3 showing die holder 1 in relation to the cold plate 10, the insulation plate 11, the heated die cavity plate 13 and the bolting arrangement;

FIG. 5 is a sectional perspective view of the preferred embodiment of the die structure as the die member closes in to the garment 5 as supported by back plate 6 within an air gap 35 allowing gas and air to vent and further comprises of injection nozzles 20A, 20B, 20C and 20D with nozzle tips 21A, 21B, 21C and 21D connecting to injection lines 26,27,28 and 29 delivering corresponding polymeric material 30, 31, 32 and 33 into the peripheral space of the graphical design 36 adapted to discrete design portions located apart; and

FIG. 6 is a frontal view of the outside surface of the improved garment 5 comprises of the graphical design 36 with discrete design elements 22, 23, 24 and 25;

FIG. 7 is a sectional elevation view of the discrete design element 25 comprises of uniformly varied thickness of the graphical design portions 38,37,39 and 40, and curvilinear design elements 38 and 41;

FIG. 8 is a schematic diagram of the injection for delivering five (5) discrete colored polymeric material comprising metered injectors 42A, 42B, 42C, 42D and 42E connecting to corresponding block valve A, B, C, D, and E and chilled injection lines 43A, 43B, 43C, 43D and 43E and subsequently connecting to the corresponding manifolds 44A, 44B, 44C, 44D and 44E where the polymeric material spirally flows through; and

FIG. 9 is a perspective view of the injection nozzle comprises of the removable body 20 with the independently removable nozzle tip 21.

### DETAILED DESCRIPTION OF THE PREFERRED EMBODIMENT

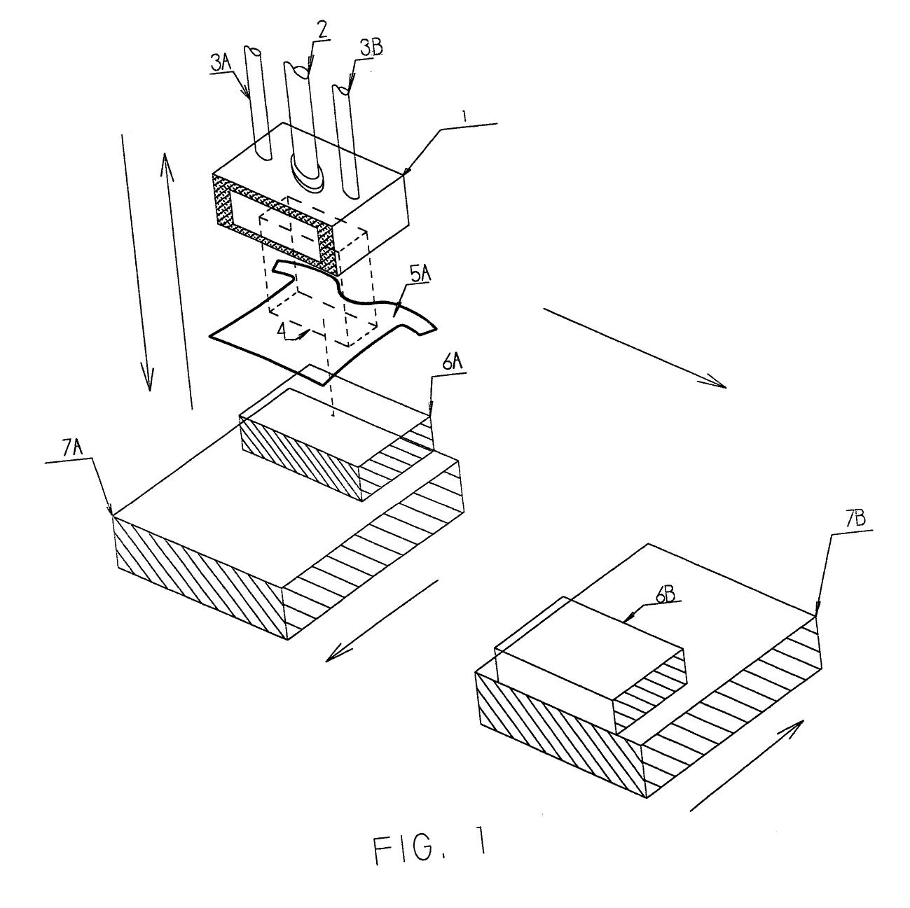

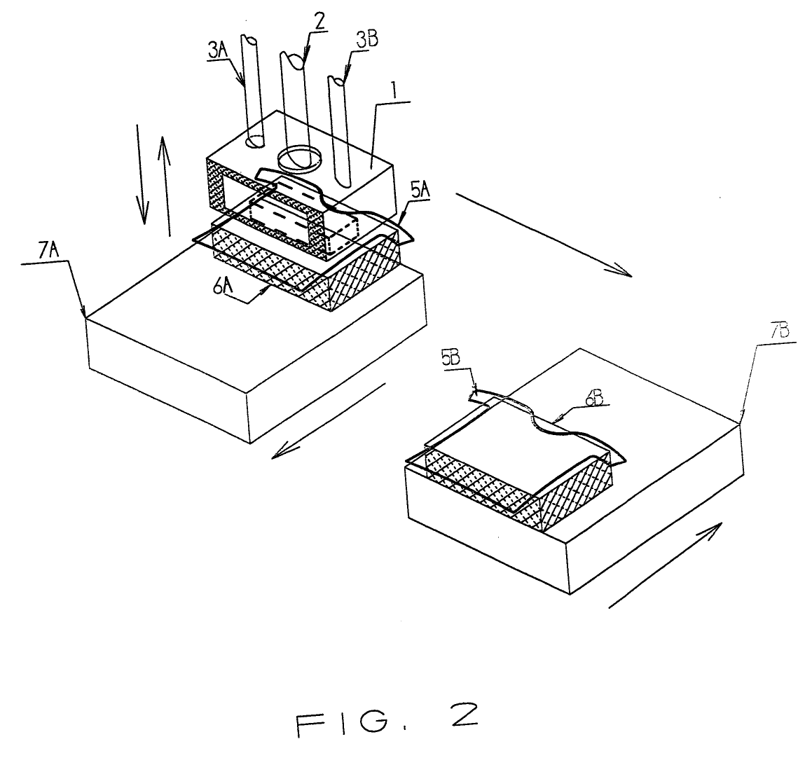

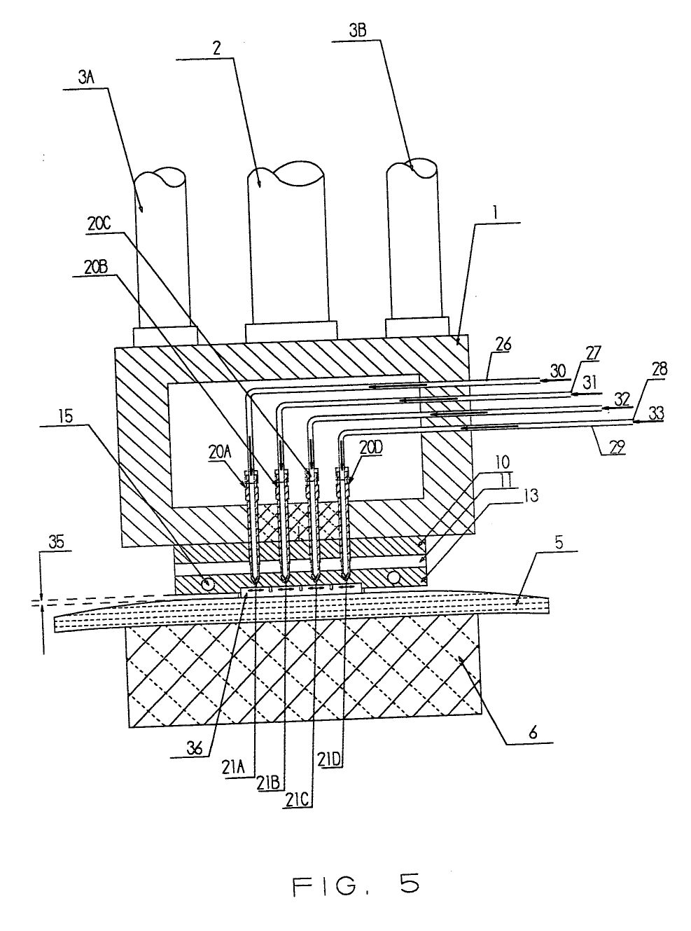

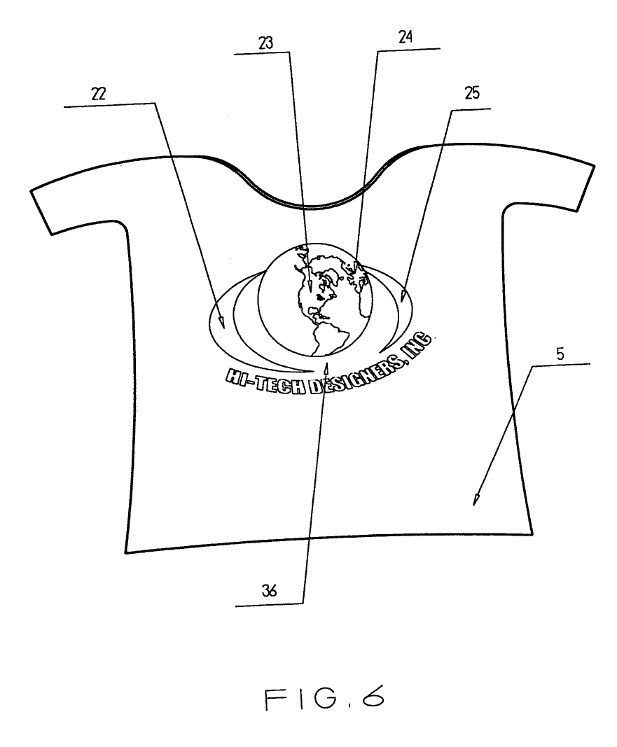

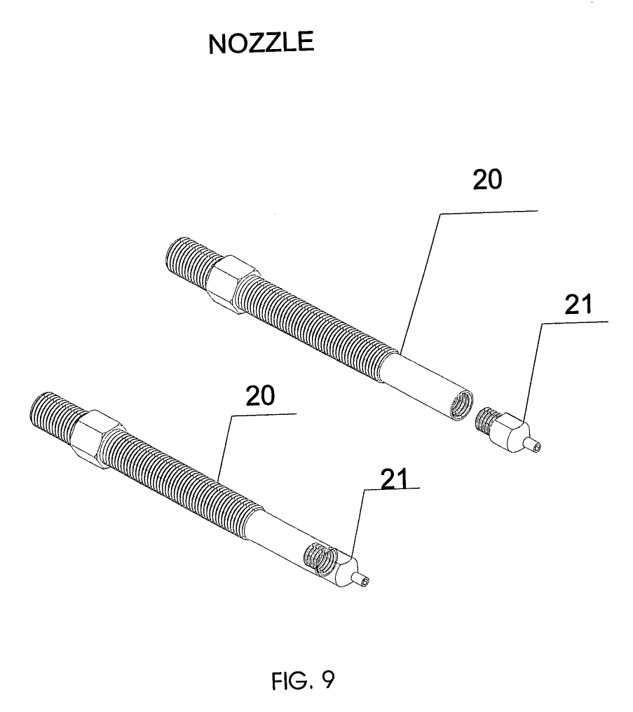

In FIGS. 1-9, the method of the present invention is shown with the enabling die structure and injection system. The garment 5 of the present invention is seen in FIG. 6 once the graphic design elements 22, 23, 24 and 25 of the graphic design 36 have been bonded to the garment 5 outside surface. In FIG. 1, a typical garment 5A is shown in position between the die press members, which are held within die holder 1, and a back plate 6A, which is adapted to a movable table 7A. The directional arrows indicate the possible variation in motion and direction of the die members and the back plate. An identical set of back plate 6B adapted to a movable 6B allows the process to repeat subsequent to the completion of the same process at the position of back plate 6A. In FIG. 5, the garment 5 has an outside surface and an inside surface such as the opposing inside surface of the shirt. The backing plate 6 would simply be placed under the shirt at the rear or inside surface of the shirt front panel. The shirt fabric layer is being sandwiched in between die press member 13 and backing plate press member 6 while separated by an air gap 35. The garment 5 has an outside surface that will receive the graphic design and will bond to such design whereas the inside surface, which is directly opposing that outside surface, retains its original state.

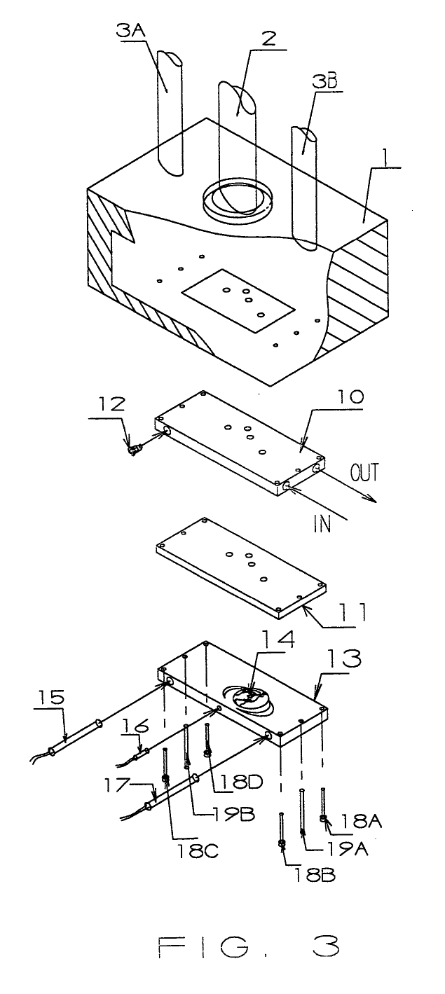

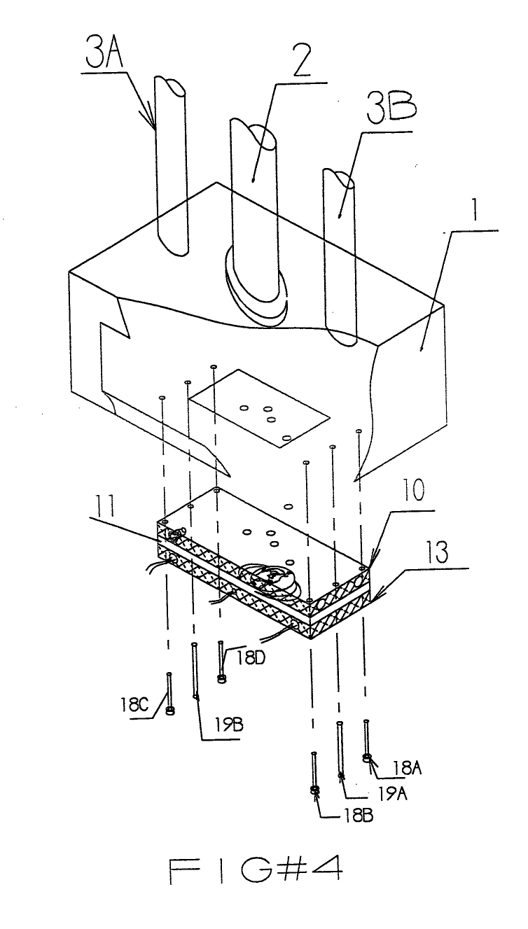

The arrows in FIG. 1, show the hydraulic ram 2 with the guides 3A and 3B move the die members 10, 11 and 13 which are bolted to a die holder 1 (see FIGS. 3 and 4) to engage with garment 5 (see FIG. 5) so that the fabric layer of garment 5 is narrowly separated by an air gap 35 as the garment 5 is positioned in between the die press member 13 and the backing plate 6. This air gap is important because an injection moldable polymer such as silicone polymer or silicone rubber will be injected into the plurality of design element shaped cavities 14 of die press member 13 (see FIG. 3) according to the method of the present invention. The backing plate press member 6 has an upper surface that engages the inside surface of garment 5 and a lower surface, which is adapted to a controllably movable table. For purposes of illustration, the fabric layer is shown as a thick layer in FIG. 5. However, it should be understood that a garment layer of garment 5, such as on a T-shirt will typically be quite thin, usually no more than a few millimeters in thickness.

Die press member 13 carries four design element shaped cavities attributed to discrete design elements 22, 23, 24 and 25. Each cavity is of a shape of a discrete design element that is to be attached to garment 5. These discrete elements can be, for example, letters, numbers, artistic logos, graphical representations, or the like as shown in FIG. 6. The discrete elements including element 36 are shown as including a plurality of letters and logo designs 22, 23, 24 and 25.

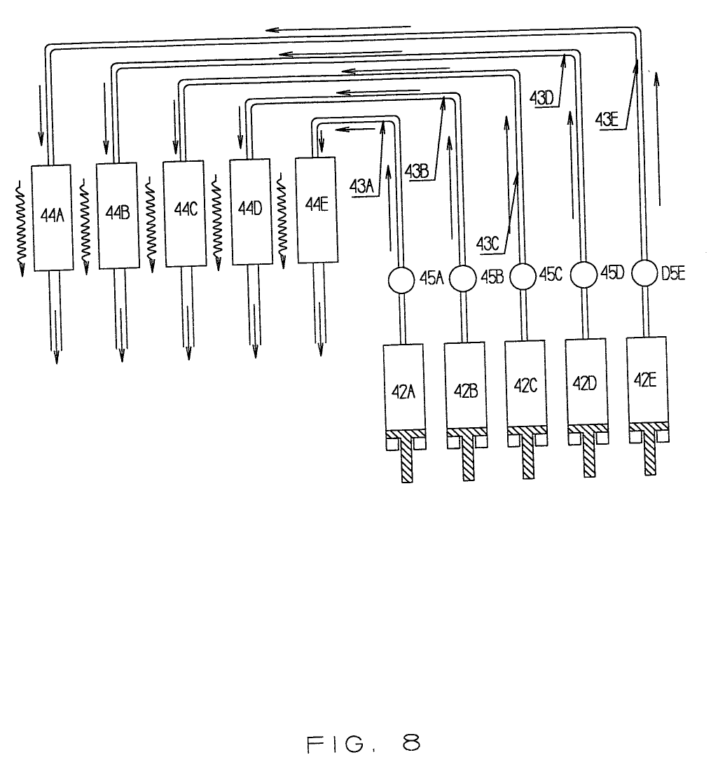

The method of the present invention preferably utilizes an injection moldable polymer such as a silicone polymer, which can be heated to a curing temperature as the polymer contacts the peripheral surface of the heated die cavity 14. In the method of the present invention, it is preferred that the mold 13 and injection moldable silicone polymer be heated to a temperature of about 200-250 degrees Fahrenheit (200° F.-250° F.). The injection moldable silicone polymer is drawn from individual container through a chilled injection line to a color dye mixer then transferred to an individual injector, which is connected to an individual block valve, then to another injection line which is connected to a manifold and then to the injection nozzle adapted to the die member 13. An injection line is constructed to communicate independently to the die cavity. Each injection is connected respectively to a die cavity corresponding to discrete design elements 22, 23, 24, 25 and 36. By using distinct individual injection lines 43A, 43B, 43C, 43D or 43E, silicone polymer of a different color can be transmitted to the die cavity that corresponds to the corresponding element 22 as compared to the color used for the elements 23, 24, 25 and 36. In addition, the independently controlled injection line provides different shot size as required by the size of the logo or the text. FIG. 5 and FIG. 8 schematically illustrate the flow of injection moldable silicone polymer to corresponding graphic design die cavities.

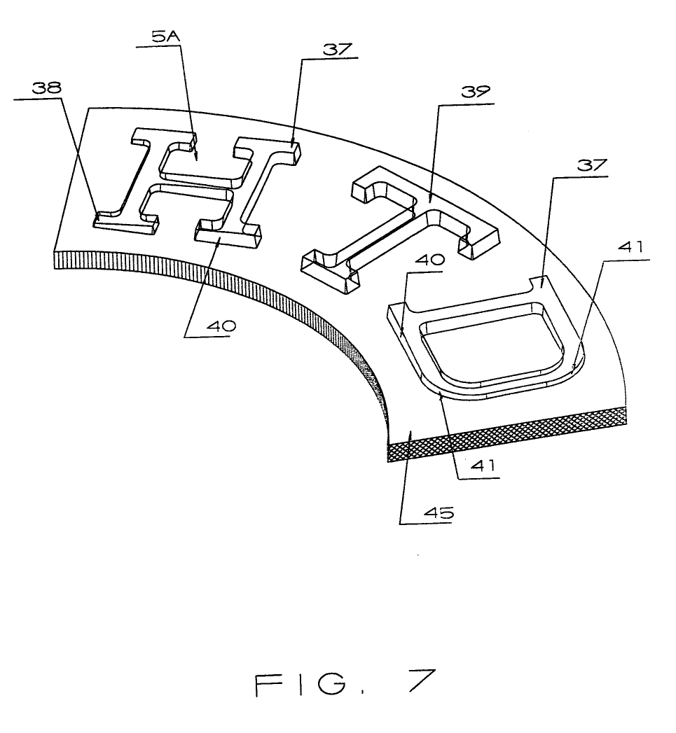

In FIG. 7, a portion of the design element 25 is shown in more detail in section elevation view. The element 25 has bonded to the outside surface of garment 5. Because injection molding is used to form the element 25, it has a distinct shaped appearance that includes a uniformly varied flat upper surface 38, a flat peripheral surface 38, and a sharp edge is formed by the intersection of the flat upper surface 37 and the flat peripheral surface 40. An angle of about ninety degrees (90°) is formed between flat upper surface 38 and flat peripheral surface 40. The angle can be about ninety degrees (90°) or can be an obtuse angle of about ninety-one to one hundred degrees (91-100°). Each die cavity has a shape that corresponds with a shape that corresponds with the shape of the elements 22, 23, 24, 25 and 36 to be formed. Therefore, each cavity has surfaces 37,38,39,40,41 and 45 that define the shape such as the shape of element 25 in FIG. 7. Each cavity 22-24 has a peripheral surface 25, a flat upper surface 26 and a sharp edge surface portion 27.

FIG. 5 is an illustration of a part of the method of the present invention. In FIG. 5, the liquid silicone rubber or silicone polymer travels from the corresponding manifold 44 (see FIG. 8) via injection lines 30, 31, 32 and 33 and carrying distinct amount of material and color. The silicone travels through chilled injection line and acquires the curing temperature as it passes through the heated peripheral surface of the die cavity 14 of the die member 13. An insulation layer 11 that is sandwiched in between the hot plate 13 and the cold plate 10 provides the thermal barrier to maintain the chemical integrity of the silicone as such the silicone is not prematurely cured before reaching the die cavity. A thermal sensor 16 relays the temperature of the hot plate 13 to a PLC and the heat input is regulated to maintain a temperature of about 200-250 degrees Fahrenheit (200° F.-250° F.).

Because many varying and different embodiments may be made within the scope of the inventive concept herein taught, and because many modifications may be made in the embodiments herein detailed in accordance with the descriptive requirement of the law, it is to be understood that the details herein are to be interpreted as illustrative and not in a limiting sense.

1. A method of injecting polymer onto substrates, which comprises:
having a die structure with a first member being a hot plate having a cavity with a graphical design, a second member being an insulation layer, and third member being a cold plate, and collectively defines as die members;
engaging a substrate having an inner surface and outer surface onto an automated table adapted to receive and secure at least a back plate, and controllably moving to a desired position;
guiding the substrate into the desired position opposing the die members;
charging a supply system of the die members with polymer;
moving the die members to the opposing outside surface of the substrate forming an air gap;
applying a controlled amount of polymer to said surface of said substrate;
moving the die members away from the substrate and disengaging the substrate from the desired position;
releasing the substrate; and
engaging a subsequent substrate.

2. The method of claim 1, wherein said applying comprises:
forcing pressurized polymer in a controllable sequence onto the outside surface of the substrate having the backplate controllably moves the substrate to desired positions.

3. The method of claim 1, wherein said forming an air gap comprises:
moving the die members closely to the surface of the substrate;
creating a sufficient gap between the die member opposing the substrate and the substrate; and
permitting hot gas to escape.

4. The method of claim 1 wherein said charging a supply system comprises:
providing polymer to an injection system with at least one injector adaptable to communicate to the die members; and
pressurizing the supply system.

5. The method of claim 1 wherein said disengaging the substrate comprises:
moving laterally the automated table away from the die members; and
depositing the substrate externally to the die members.

6. The method of claim 1, wherein said applying comprises:
forming a plurality of graphical design in subsequent injections by forcing pressurized polymer in a controllable sequence onto the outside surface of the substrate having the backplate controllably moves the substrate to desired positions.

7. The method of claim 6, wherein said applying is performed substantially simultaneously.

8. The method of claim 1 comprises:
providing a plurality of polymers; and
injecting said polymers individually.

9. The method of claim 1 wherein said charging a supply system comprises:
providing a plurality of polymers; and
mixing said polymers to form the said polymer.

10. A method of injecting polymer onto substrates, which comprises:
providing a plurality of sets of die members wherein each set having a first member being a hot plate, a second member being an insulation layer, and a third member being a cold plate;
positioning a substrate having an inner surface and outer surface onto an automated table adapted to receive and secure at least a set of back plate, and controllably moving to position;
guiding the substrate into a position opposing the face of the first members;
charging a supply system of the die members with polymer;
moving the die members closely to an outside surface of the substrate opposing the surface of the first die members to sufficiently form an air gap in-between the surfaces;
applying a controlled amount of heated polymer to a surface of said substrate;
disengaging the substrate from the die members;
transferring the substrate to the subsequent set of die members;
applying a controlled amount of heated polymer to a surface of said substrate;
engaging a subsequent substrate;
and releasing the previous susbtrate.
